(19) United States
(12) Patent Application Publication
(10) Pub. No.: US 2011/0152022 A1
(43) Pub. Date: Jun. 23, 2011

(54) TENSIONER UNIT

(75) Inventors: SHINTAROU YOSHIMOTO, Osaka (JP); OSAMU YOSHIDA, Osaka (JP); TSUTOMU NAMIE, Osaka (JP)

(73) Assignee: TSUBAKIMOTO CHAIN CO.,, Osaka (JP)

(21) Appl. No.: 12/963,188

(22) Filed: Dec. 8, 2010

(30) Foreign Application Priority Data
Dec. 21, 2009 (JP) 2009-289304

(51) Int. Cl. F16H 7/08

(52) U.S. Cl. 474/110

(57) ABSTRACT

A tensioner unit comprises a tensioner body, a gasket in overlapping relationship to the tensioner body whereby the gasket can be sandwiched between the tensioner body and a mounting surface to which the tensioner body is to be secured, and a threaded mounting bolt inserted through a mounting hole in the tensioner body for securing the tensioner body to the mounting surface. A bolt hole is provided in the gasket, and the mounting bolt also extends through the bolt hole. The gasket grips the bolt and holds the mounting bolt, the gasket, and the tensioner body, in fixed relationship to one another, and maintains the gasket in a predetermined aligned relationship with the tensioner body when the gasket is in overlapping relationship with the tensioner body during mounting of the tensioner body on the mounting surface.

### CROSS REFERENCE TO RELATED APPLICATION

This application claims priority on the basis of Japanese Patent Application 2009-289304 filed Dec. 21, 2009. The disclosure of Japanese Patent Application 2009-289304 is herein incorporated by reference.

### FIELD OF THE INVENTION

The invention relates to a tensioner unit for maintaining adequate tension in the chain of a chain transmission, such as the timing chain in an internal combustion engine.

### BACKGROUND OF THE INVENTION

As shown in FIGS. 15 and 16, a prior art tensioner unit 500 for use in a timing drive of an internal combustion engine comprises a tensioner body 510 having a plunger 512 that is movable in and out of the tensioner body, and a gasket 520, which is sandwiched between the tensioner body 510 and a mounting surface (not shown), which is usually a surface of an engine block. The purpose of the gasket is to prevent leakage of oil, which is supplied under pressure to the tensioner through a port in the engine block. The tensioner unit 500 is arranged so that the tensioner body 510 and the gasket 520 are fixed to the mounting surface by mounting bolts 530, which extend through mounting holes 511 in the tensioner body 510 and through bolt holes 521 in the gasket 520 and are threaded into threaded holes in the engine block or other structure on which the mounting surface is formed.

Because the tensioner body 510, the gasket 520, and the mounting bolts 530, are supplied as separate components, the task of attaching the tensioner body and gasket to the mounting surface is cumbersome. For the same reason, it is difficult to ensure that the gasket 520 is accurately positioned in relation to the port and the bolt holes in the mounting surface and in relation to the corresponding port and bolt holes in the tensioner body.

If the gasket 520 is misaligned, the fastening pressure of each mounting bolt 530 is not applied evenly around the bolt holes 521 in the gasket, inadequate sealing can occur, and deformation of the gasket resulting from biased forces can make it impossible to reuse the gasket. Japanese laid-open patent application Hei. 9-32893 discloses an approach taken to alleviate the problem of gasket positioning inaccuracy. According to that approach, an engaging element is provided in the inner peripheral portion of a bolt hole in a gasket in order to facilitate alignment of the gasket with the bolt hole. However, because the tensioner body, gasket, and mounting bolt are supplied separately, the positional relationship between the tensioner body and the gasket must be adjusted when the gasket and tensioner body are assembled. Assembly and mounting of the tensioner is cumbersome, and assembly must be carried out carefully to ensure reliable gasket positioning accuracy.

### SUMMARY OF THE INVENTION

The invention addresses the aforementioned problems of the prior art by providing a tensioner unit that facilitates assembly, has a simple structure, improves the sealing function of the gasket by reliably ensuring gasket positioning accuracy, and permits reuse of the gasket.

The tensioner unit according to the invention comprises a tensioner body, a gasket in overlapping relationship to the tensioner body whereby the gasket can be sandwiched between the tensioner body and a mounting surface to which the tensioner body is to be secured, and a threaded mounting bolt inserted through a mounting hole in the tensioner body for securing the tensioner body to the mounting surface. A bolt hole is provided in the gasket, and the mounting bolt also extends through the bolt hole.

The gasket includes a bolt gripping means for temporarily holding the mounting bolt, the gasket, and the tensioner body, in fixed relationship to one another, and maintaining the gasket in a predetermined aligned relationship with the tensioner body and the mounting bolt when the gasket is in overlapping relationship with the tensioner body during mounting of the tensioner body on the mounting surface.

When the tensioner body, gasket, and mounting bolt are supplied as a unit and the mounting bolt, gasket and tensioner body are in a predetermined relationship to one another, assembly of the tensioner is facilitated.

Preferably, the gasket has a convex part with cylindrical inner and outer surfaces. The convex part is received in the mounting hole of the tensioner body, and the bolt hole of the gasket is disposed in the convex part of the gasket within the mounting hole of the tensioner body. The bolt-gripping means comprises the convex portion of the gasket and an O-ring within the convex portion of the gasket. The O-ring, when relaxed, has an outer diameter larger than the inner diameter of the convex part when the convex part is received in the mounting hole, and, when relaxed, has an inner diameter smaller than the outer diameter of the threads of the mounting bolt.

The use of the O-ring in cooperation with the convex part of the gasket ensures an accurate positional relationship between the tensioner body and the gasket, and the resilience of the O-ring holds the mounting bolt firmly in the gasket. Because the mounting bolt can be tightened to fix the tensioner unit to its mounting surface while the positional relationship between the gasket and the mounting bolt is maintained, assembly of the tensioner unit is facilitated, and gasket positioning accuracy is improved.

Where the gasket has a convex part received in the mounting hole of the tensioner body, the bolt hole of the gasket is disposed in the convex part of the gasket within the mounting hole of the tensioner body. The bolt-gripping means can comprise an inner peripheral portion of the bolt hole in engagement with threads of the mounting bolt. This embodiment ensures accurate positional relationship between the tensioner body and the gasket by inserting the convex part into the mounting hole. Moreover, because the mounting bolt can be tightened to fix the tensioner unit to its mounting surface while the positional relationship between the gasket and the mounting bolt is maintained, assembly of the tensioner unit is facilitated, and gasket positioning accuracy is improved.

When the mounting hole of the tensioner body has a cylindrical inner surface, the bolt hole of the gasket is disposed in an end surface of the convex part, and the convex part has a plurality of slots which permit resilient expansion of the convex part toward the cylindrical inner surface of the mounting hole of said tensioner body, the gasket is held in the tensioner body even when the mounting bolt is not inserted. Accordingly, it is possible to assemble the tensioner body and gasket easily before mounting of the tensioner unit and to ensure an accurate positional relationship between the tensioner body and the gasket.

In another embodiment of the tensioner unit, the bolt hole of the gasket has an inner peripheral surface, and the gasket comprises a sheet-like core having a compressible surface coating layer for enhancing sealing between the gasket and an adjacent surface. In this embodiment, the bolt-gripping means is composed of a bulging part of the coating layer on the inner peripheral surface of the bolt hole of the gasket, and the relaxed inner diameter of the bulging part is smaller than the outer diameter of screw threads of the mounting bolt. The mounting bolt is firmly held in the gasket by the resilience of the bulging part. Here, as in other embodiments, the mounting bolt can be tightened to fix the tensioner unit to its mounting surface while the positional relationship between the gasket and the mounting bolt is maintained, assembly of the tensioner unit is facilitated, and gasket positioning accuracy is improved.

The coated gasket can be formed with a convex part to be received in a mounting hole in the tensioner body, and with the bulging part of the coating forming the inner periphery of a bolt hole in the end of the convex part. Here again the bolt can be tightened while being held in the gasket while the bolt, gasket and tensioner body are in proper positional relationship to one another for easy mounting.

### BRIEF DESCRIPTION OF DRAWINGS

FIG. 1 is a sectional view of a part of a tensioner unit according to a first embodiment of the invention, comprising a tensioner body with a mounting bolt and gasket held thereon;

FIG. 2 is a sectional view showing the tensioner body of FIG. 1 fastened to a mounting surface by the bolt;

FIGS. 3a and 3b are enlarged plan and sectional views, respectively, of the convex portion of the gasket shown in FIG. 1;

FIGS. 4a and 4b are enlarged plan and sectional views, respectively, of the convex portion of a modified gasket;

FIG. 5 is a sectional view of a part of a tensioner unit according to a second embodiment of the invention, comprising a tensioner body with a mounting bolt and gasket held thereon;

FIG. 6 is an enlarged view of a part of tensioner unit of the kind shown in FIG. 5, in which the convex portion of the gasket inserted into the mounting hole of the tensioner body is modified;

FIG. 7 is an enlarged view of a part of tensioner unit of the kind shown in FIG. 5, showing another modification of the convex portion of the gasket inserted into the mounting hole of the tensioner body;

FIG. 8 is an enlarged view of a part of tensioner unit of the kind shown in FIG. 5, showing still another modification of the convex portion of the gasket inserted into the mounting hole of the tensioner body;

FIGS. 9a and 9b are respectively plan and sectional views of a gasket according to the invention;

FIG. 10 is a sectional view of a part of a tensioner unit according to a third embodiment of the invention with a mounting bolt and gasket held on the tensioner body;

FIG. 11 is a sectional view of a part of a tensioner unit according to the third embodiment of the invention with a mounting bolt and a modified gasket held on the tensioner body;

FIG. 12 is an enlarged schematic view illustrating how a hole in gasket according to the invention mates with a mounting bolt;

FIG. 13 is an enlarged schematic view illustrating how a hole in a modified gasket according to the invention mates with a mounting bolt;

FIG. 14 is an enlarged schematic view illustrating how a hole in a still another modified gasket according to the invention mates with a mounting bolt;

FIG. 15 is an exploded perspective view of a prior art tensioner unit; and

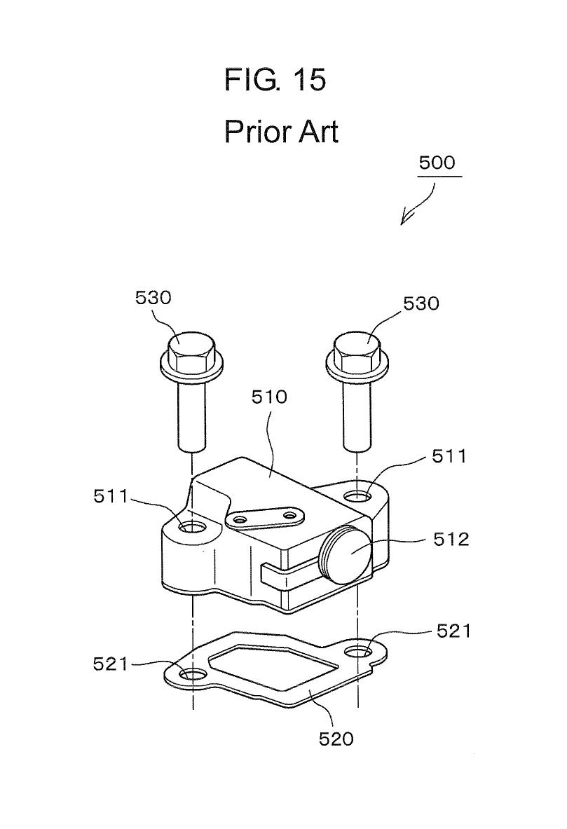

FIG. 16 is a perspective view showing the prior art tensioner unit when assembled.

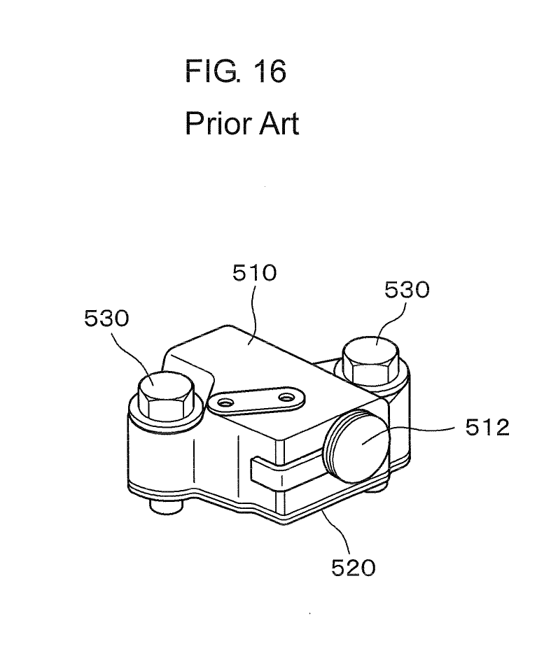

### DETAILED DESCRIPTION OF THE PREFERRED EMBODIMENTS

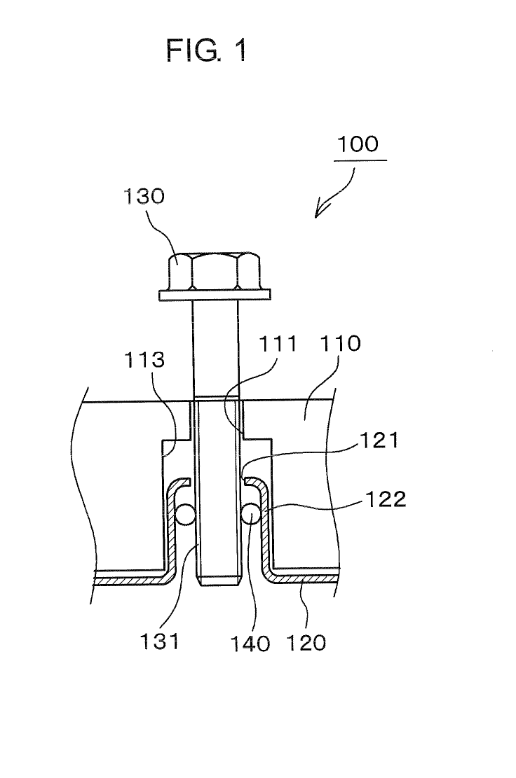

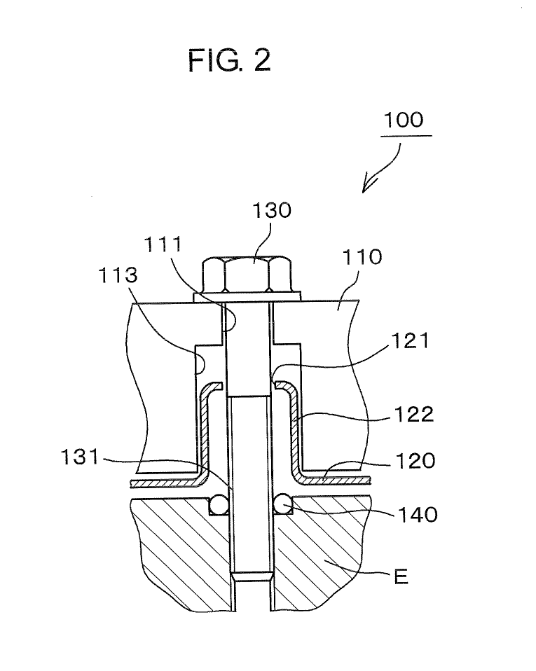

As shown in FIGS. 1 and 2, the tensioner unit 100 of the first embodiment of the invention comprises a tensioner body 110, a gasket 120 adapted to be sandwiched between the tensioner body and a mounting surface, in this case an engine block E as shown in FIG. 2, and a mounting bolt 130, inserted through a mounting hole 111 in the tensioner body and through a bolt hole 121 in the gasket 120. The bolt is typically one of a plurality of bolts used to fix the tensioner body to the engine block.

The bolt hole 121 of the gasket 120 is provided in an end portion of a convex part 122 that has a generally cylindrical outer surface and is inserted into an enlarged diameter part 113 of the mounting hole 111 extending into the tensioner body from the face thereof on which the flat part of the gasket is situated.

As shown in FIG. 1, the gasket 120 is held in proper alignment with the tensioner body by insertion of its convex portion 122 into the large-diameter portion 113 of the mounting hole. An O-ring 140 is disposed in the space between the threaded part of the bolt and the inner wall of the cylindrical part of the convex portion of the gasket. The relaxed outer diameter of the O-ring is larger than the inner diameter of the convex portion 122, and its relaxed inner diameter is smaller than the outer diameter of the screw threads 131 of the bolt 130. By virtue of its resilience, the O-ring 140 grips the mounting bolt, and holds the mounting bolt 130 in fixed relation to the convex portion 122 of the gasket. Thus, it is possible to supply the tensioner body 110, the gasket 120, and one or more mounting bolts 130, as an integrated tensioner unit ready for mounting on an engine block or other mounting surface.

As shown in FIG. 2, the O-ring and convex portion of the gasket can reliably ensure accurate positioning of the gasket 120 without requiring cumbersome measures to maintain the gasket in place. Furthermore, because the pressure of the mounting bolt 130 is applied uniformly around the convex part of the gasket 120, the gasket is not biased or deformed, and an improved seal can be achieved. Moreover, because the gasket is not deformed it can be re-used after the tensioner unit is removed from the engine block for maintenance.

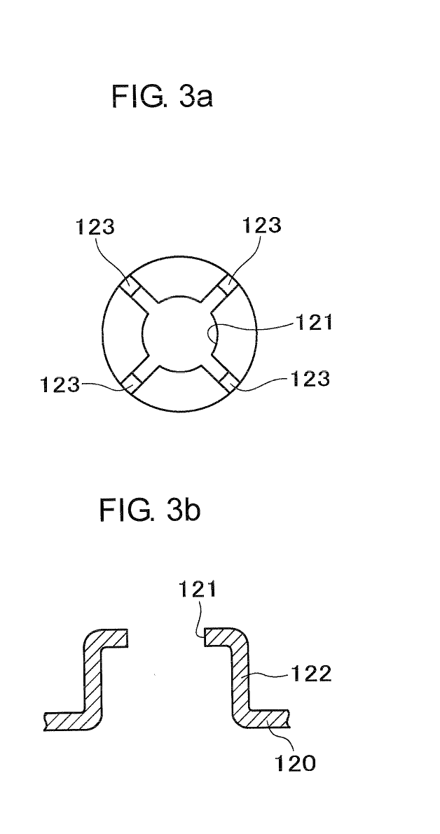

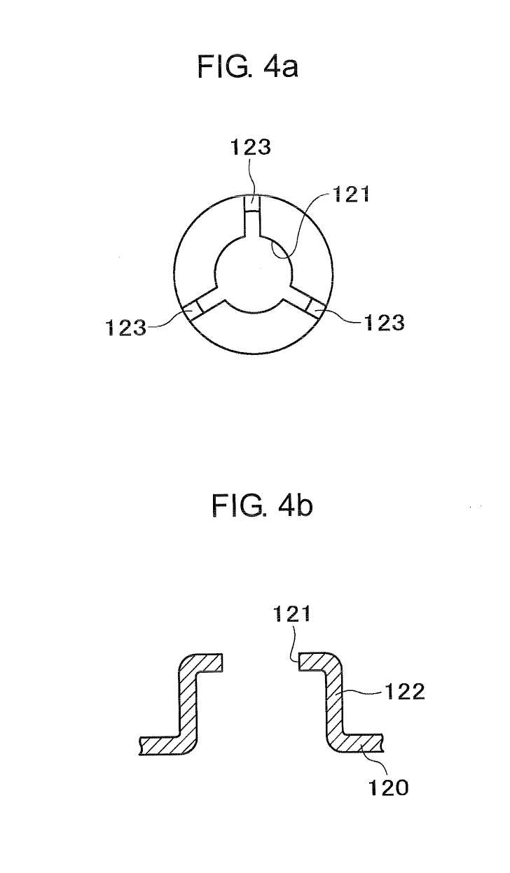

As shown in FIGS. 3a, 3b, 4a and 4b, it is also possible to provide a plurality of slots 123 in the convex portion 122 of the gasket 120 so that it can expand resiliently outward and into engagement with the inner surface of the large-diameter portion 113 of the mounting hole (FIGS. 1 and 2). These slots extend radially outward from the bolt hole and at least part way in the axial direction toward the flat part of the gasket. Because the slots allow resilient expansion of the convex portion, the gasket can be more firmly held to the tensioner body 110 even if the mounting bolt 130 is not inserted. Therefore, the slots make it possible to integrate the gasket with the tensioner unit 100 before the bolts are inserted, and ensure improved accuracy of the positional relationship between the tensioner body 110 and the gasket 120. The outer diameter of the inserted convex portion 122 may be selected to fit closely the inner peripheral surface of large diameter portion 113 of the mounting hole large-diameter portion 113, in which case similar objectives can be achieved without slots 123.

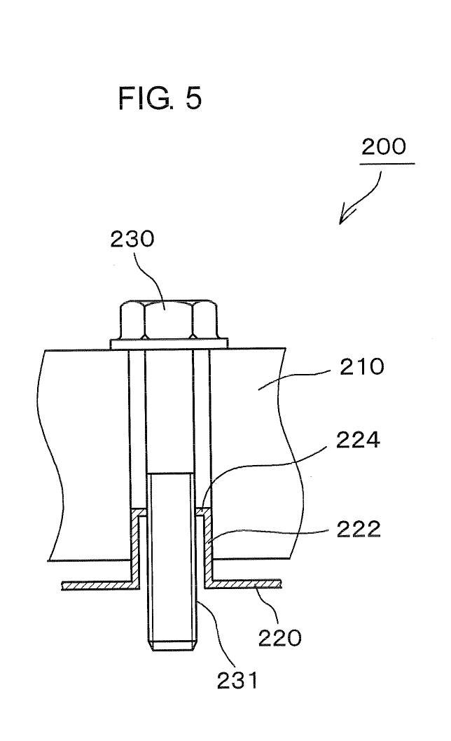

As shown in FIG. 5, a tensioner unit 200, according to a second embodiment of the invention, comprises a tensioner body 210, a gasket 220 adapted to be sandwiched between the tensioner body 210 and a mounting surface such as a surface of an engine block. A mounting bolt 230 is inserted through a mounting hole provided in the tensioner body 210 and through a bolt hole provided in the gasket 220 to fix the tensioner body 210 to the mounting surface.

The bolt hole of the gasket 220 is provided in the end portion 224 of a convex portion 222 having a cylindrical outer surface. The convex portion is inserted into the mounting hole of the tensioner body 210 and the inner peripheral surface of the end portion 224 serves as an engaging piece, mating with the screw thread 231 of the mounting bolt 230. Thus, it becomes possible to supply the tensioner body 210, the gasket 220, and the mounting bolt 230, in a pre-assembled condition in which the tensioner body, gasket, and bolt are held in a predetermined relationship to one another.

As in the first embodiment, it becomes possible to ensure reliable positioning accuracy of the gasket 220 without requiring cumbersome repositioning of the gasket during the process of mounting the tensioner on an engine block. Uniform pressure applied to the gasket when the mounting bolt is tightened, improves the seal, and, because the gasket 220 is not biased or deformed, it can be re-used.

The convex portion 222 is constructed to fit closely in the inner periphery of the mounting hole of the tensioner body 210. Consequently, the gasket is held by tensioner body even when the mounting bolt 230 is not inserted. Consequently, assembly of the tensioner unit is made easier, and more accurate positioning of the gasket relative to the tensioner body is achieved.

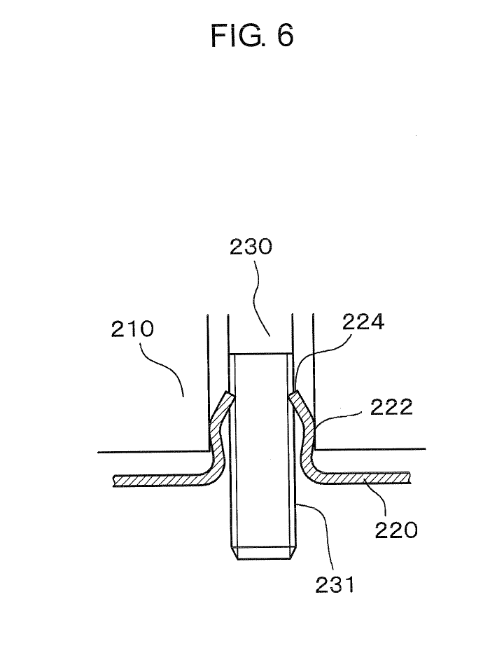

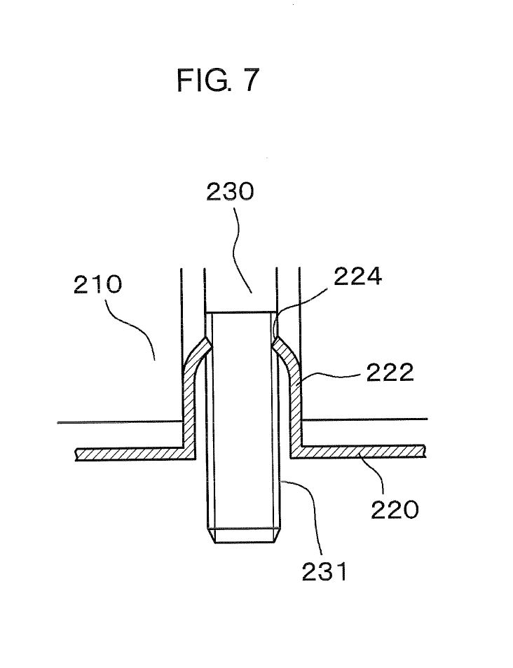

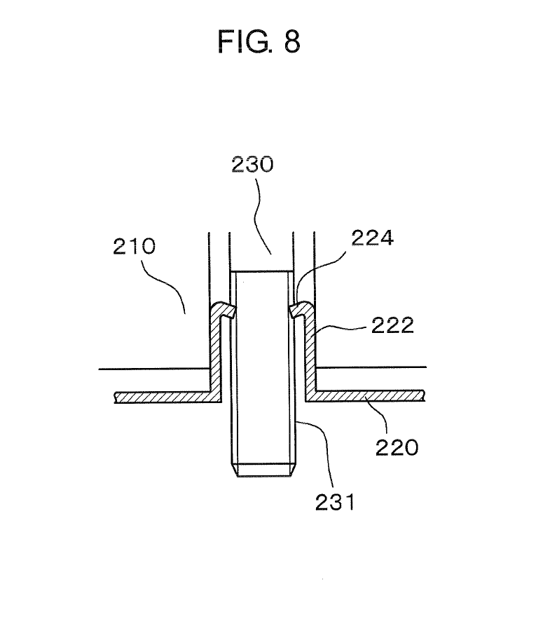

The outer surface of convex portion 222 can be formed into a simple cylindrical shape as shown in FIGS. 5, 7 and 8, or can be formed with a bulging central part as shown in FIG. 6. The bolt thread-engaging part 224 of the convex portion of the gasket can be formed to project horizontally as in FIG. 5, or can incline upward as in FIGS. 6 and 7 or downward as in FIG. 8.

The shapes and combinations of the convex portion 222 and the bolt thread-engaging part 224 are not limited to those illustrated in FIGS. 5 through 8, and other shapes and combinations can be adopted as long as the tensioner body 210, the gasket 220 and the mounting bolt 230 are held in a fixed relationship when the mounting bolt 230 is inserted and the bolt thread-engaging part 224 mates with the threads 231 of the mounting bolt 230.

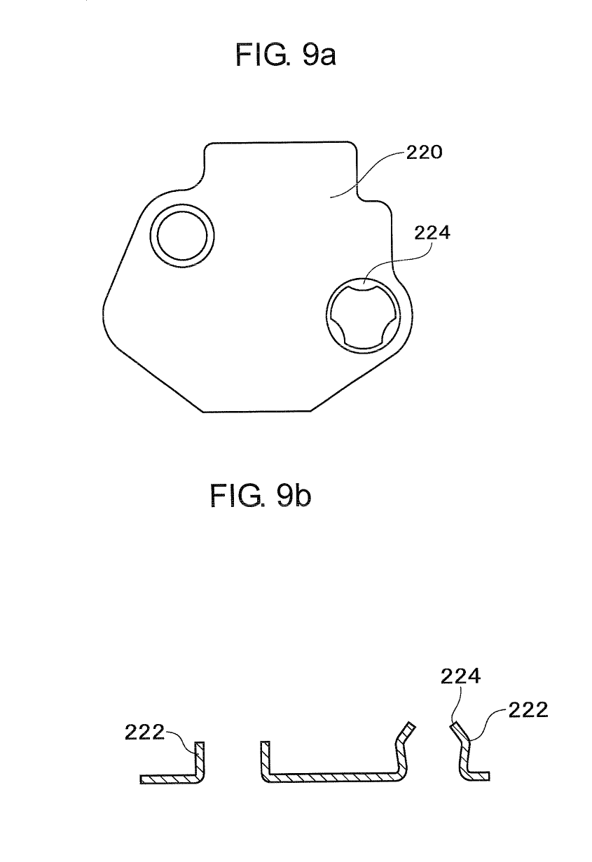

As shown in FIGS. 9a and 9b, when there are two or more bolt holes in the gasket 220, at least one convex portion 222 and at least one bolt thread-engaging part 224 may be provided. However, depending on the number of bolt holes, any number of convex portions and bolt-engaging parts 224 can be provided. Similarly, in the first embodiment, any number of the convex portions 122 and O-rings 140 can be provided as long as they are provided at least at one location.

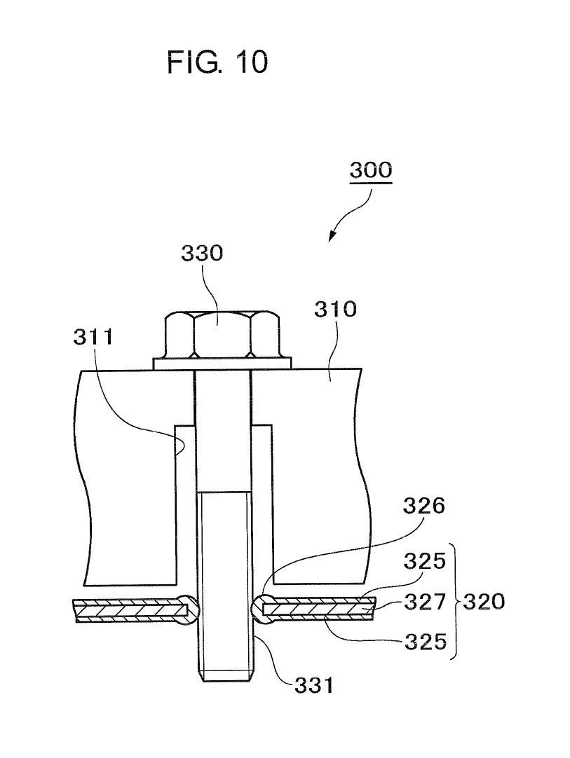

As shown in FIG. 10, a tensioner unit 300, according to a third embodiment of the invention, comprises a tensioner body 310, a gasket 320 adapted to be sandwiched between the tensioner body 310 and a mounting surface, e.g., the surface of an engine block, and a mounting bolt 330 inserted through a mounting hole 311 in the tensioner body 310 and through a bolt hole in the gasket 320 to fix the tensioner body 310 to the mounting surface.

The gasket 320 comprises a thin, sheet-like core 327 having a compressible coating layer 325 on both sides. The compressible coating provides the gasket with superior sealing properties. A bolt-engaging part 326 is formed by a bulging part of the coating at the inner periphery of a bolt hole formed in the gasket. The bolt-engaging part 326 has an inner diameter smaller than the outer diameter of the screw threads 331 of the mounting bolt 330. The tensioner body 310, the gasket 320 and the mounting bolt 330 can be supplied in a pre-assembled condition with the bolt and gasket in a predetermined fixed relationship to each other when the bolt engaging part 326 mates with the thread 331 of the inserted bolt 330.

It is possible to ensure reliable positioning accuracy of the gasket 320 without requiring cumbersome measures to adjust the position of the gasket during mounting of the tensioner unit on a mounting surface. The fastening pressure is applied by the mounting bolt 330 uniformly around the bolt hole of the gasket 320, thereby improving the sealing properties of the gasket. Furthermore the gasket is not biased or deformed and can therefore be re-used.

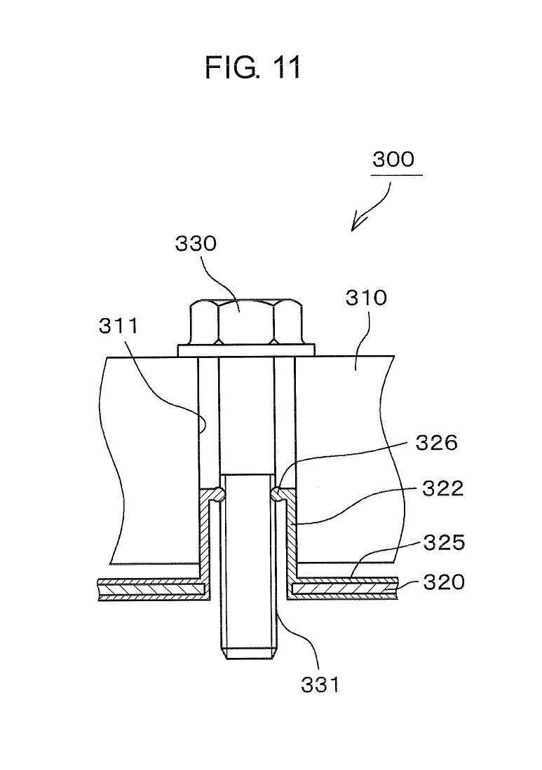

As shown in FIG. 11, the coating layer 325 of the gasket 320 may be also formed into a cylindrical convex portion 322, which is inserted into the mounting hole 311 of the tensioner body 310 and a retaining portion 326 may be formed by an inward bulge at the end of the convex portion having a relaxed inner diameter smaller than the outer diameter of the bolt threads 331.

In the embodiment shown in FIG. 11, the convex portion 322 can be made with its outer diameter fitting closely in the mounting hole 311 of the tensioner body 310. In that case, the gasket 320 is held to the tensioner body even if the mounting bolt 330 is not inserted into the bolt hole, and assembly of the tensioner unit is simplified. When the convex portion 322 of the gasket fits the mounting hole 311 closely, accurate positional relationship between the tensioner body 310 and the gasket 320 is also maintained.

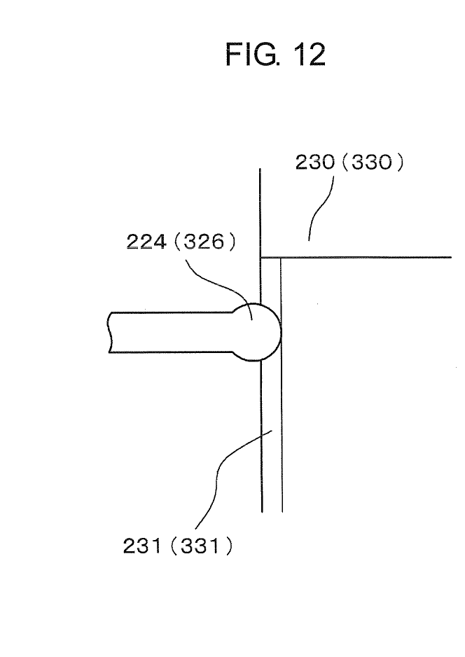

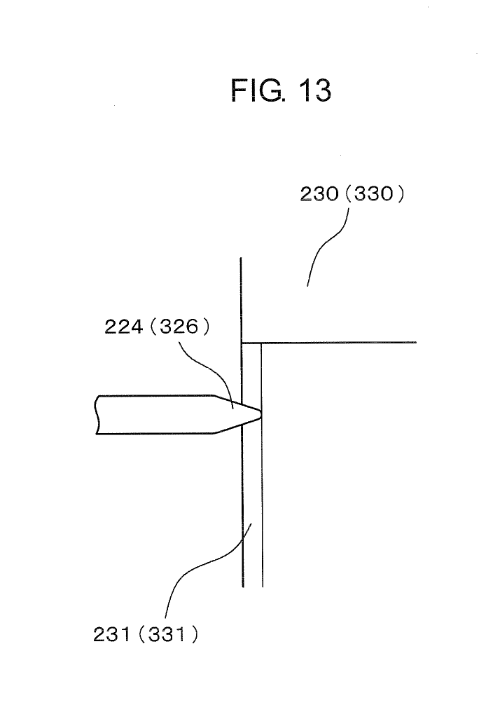

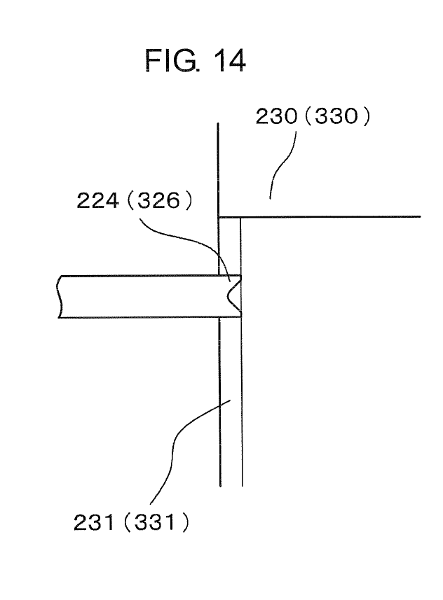

The edge of the bolt-engaging part 224 in the second embodiment that engages screw threads 231, and the retaining portion 326 in the third embodiment that engages screw threads 331 may be formed into any of various cross-sectional shapes such as a circular shape as in FIG. 12, an relatively sharp convex shape as in FIG. 13, or a concave shape as in FIG. 14, as long as they position the mounting bolt and do not hamper fastening of the tensioner to its mounting surface.

As described above, the tensioner unit of the invention facilitates assembly and mounting of a tensioner, by using a simple structure, improves the sealing properties of the gasket by ensuring accurate gasket positioning, and allows the gasket to be re-used.

Although several embodiments of the tensioner unit of the invention have been described the specific embodiments can vary in other respects, as long as the tensioner unit has a tensioner body, a gasket adapted to be sandwiched between the tensioner body and a mounting surface, and a mounting bolt inserted through a mounting hole provided in the tensioner body and a bolt hole in the gasket, and gasket has a bolt-gripping means for holding the mounting bolt when the gasket is engaged with a face of the tensioner body and aligned therewith.

What is claimed is:

1. A tensioner unit comprising a tensioner body, a gasket in overlapping relationship to the tensioner body whereby the gasket can be sandwiched between the tensioner body and a mounting surface to which the tensioner body is to be secured, and a threaded mounting bolt inserted through a mounting hole in the tensioner body for securing the tensioner body to said mounting surface, wherein a bolt hole is provided in the gasket, the mounting bolt also extends through said bolt hole, and the gasket includes a bolt gripping means for temporarily holding the mounting bolt, the gasket, and the tensioner body in fixed relationship to one another and maintaining the gasket in a predetermined aligned relationship with the tensioner body when the gasket is in overlapping relationship with the tensioner body during mounting of the tensioner body on the mounting surface.

2. The tensioner unit according to claim 1, wherein the gasket has a convex part with cylindrical inner and outer surfaces, said convex part being received in said mounting hole of the tensioner body, wherein said bolt hole of the gasket is disposed at an end portion of said convex part of the gasket within said mounting hole of the tensioner body, and wherein said bolt-gripping means comprises said inserted convex portion of the gasket and an O-ring within said convex portion of the gasket, the O-ring having a relaxed outer diameter larger than the inner diameter of said convex part when the convex part is received in said mounting hole and having a relaxed inner diameter smaller than the outer diameter of the threads of the mounting bolt.

3. The tensioner unit according to claim 2, wherein said mounting hole has a cylindrical inner surface, and wherein said bolt hole of the gasket is disposed in an end surface of said convex part, and wherein said convex part has a plurality of slots permitting resilient expansion of said convex part toward said cylindrical inner surface of the mounting hole of said tensioner body.

4. The tensioner unit according to claim 1, wherein the gasket has a convex part, said convex part being received in said mounting hole of the tensioner body, wherein said bolt hole of the gasket is disposed in said convex part of the gasket within said mounting hole of the tensioner body and wherein the bolt-gripping means comprises an inner peripheral portion of said bolt hole in engagement with threads of the mounting bolt.

5. The tensioner unit according to claim 4, wherein said mounting hole has an inner surface, wherein said bolt hole of the gasket is disposed in an end surface of said convex part, and wherein said convex part has a plurality of slots permitting resilient expansion of said convex part toward said cylindrical inner surface of the mounting hole of said tensioner body.

6. The tensioner unit according to claim 1, wherein the bolt hole of the gasket has an inner peripheral surface, said gasket comprises a sheet-like core having a compressible surface coating layer for enhancing sealing between the gasket and an adjacent surface, and said bolt-gripping means is composed of a bulging part of the coating layer on the inner peripheral surface of the bolt hole of said gasket, the relaxed inner diameter of the bulging part being smaller than the outer diameter of screw threads of said mounting bolt.

7. The tensioner unit according to claim 6, wherein the gasket has a convex part with a cylindrical outer surface, said convex part being received in said mounting hole of the tensioner body, and wherein said bolt hole of the gasket is disposed in said convex part of the gasket within said mounting hole of the tensioner body.
